(19) United States
(12) Patent Application Publication
(10) Pub. No.: US 2025/0155334 A1
(43) Pub. Date: May 15, 2025

(54) System for Agricultural Sample Slurry Analysis and Related Methods

(71) Applicant: Precision Planting LLC, Tremont, IL (US)

(72) Inventors: Reid Harman, Trivoli, IL (US); Michael Molter, Tremont, IL (US)

(21) Appl. No.: 18/838,355

(22) PCT Filed: Feb. 22, 2023
(86) PCT No.: PCT/IB2023/051626

§ 371 Date: Aug. 14, 2024

Related U.S. Application Data
(63) Continuation of application No. PCT/IB2023/051627, filed on Feb. 22, 2023.
(60) Provisional application No. 63/365,243, filed on May 24, 2022.
(60) Provisional application No. 63/365,244, filed on May 24, 2022.
(60) Provisional application No. 63/365,243, filed on May 24, 2022.
(60) Provisional application No. 63/365,244, filed on May 24, 2022.

(51) Int. Cl. G01N 1/28; G01N 9/26; G01N 9/36

(52) U.S. Cl. CPC G01N 1/286; G01N 9/26; G01N 9/36; G01N 2001/2866

(57) ABSTRACT

A system for analyzing an agricultural sample in one embodiment includes a stir chamber and a controller. The stir chamber has a housing which defines an internal cavity configured to receive an agricultural sample. A longitudinal axis extends along the internal cavity from a bottom end to a top end. First and second sensors are fluidly coupled to the internal cavity and located at first and second locations with respect to the longitudinal axis. The controller receives a plurality of signals from the first and second sensors and uses at least one of the plurality of signals to compute a density of the sample within a first region of the internal cavity located between the first and second sensors.

### CROSS REFERENCE TO RELATED APPLICATIONS

This application claims to U.S. Application Nos. 63/365,243, filed 24 May 2022, and 63/365,244, filed 24 May 2022, all of which are incorporated herein by reference in their entireties.

### BACKGROUND

The present disclosure generally relates to agricultural sampling and analysis, and more particularly to a system and associated apparatuses for analyzing a slurry from an agricultural material sample such as soil.

Periodic soil testing is an important aspect of the agricultural arts. Test results provide valuable information on the chemical makeup of the soil such as plant-available nutrients and other important properties (e.g., levels of nitrogen, magnesium, phosphorous, potassium, pH, etc.) so that various amendments may be added to the soil to maximize the quality and quantity of crop production.

In some sampling and chemical analysis processes, the raw or bulk agricultural material samples such as soil (or other agricultural materials) extracted from the field may be prepared for analysis. During analysis, the sample may be measured for various properties. Measurements may be performed to determine the chemical makeup or may be performed to ensure adequate sample size, density, or other parameters that may affect the quality of other measurements. In still other processes, measurements may be made and corrective actions taken to ensure the quality of the measurements.

Improvements in agricultural sample preparation and analysis are desired.

### BRIEF SUMMARY

The present disclosure provides a stir chamber apparatus and system and related method of use for analyzing a fluid sample. In some embodiments, the sample is an agricultural sample collected from the agricultural field or farm. The sample may be a soil sample in some non-limiting embodiments, or other agricultural-related materials described further herein amenable to chemical and other types of analysis.

In one aspect, a stir chamber has a housing, a first sensor, a second sensor, and a third sensor. The housing defines an internal cavity configured to receive an agricultural sample. The internal cavity extends along a longitudinal axis from a bottom end to a top end. The first sensor is fluidly coupled to the internal cavity of the housing at a first location with respect to the longitudinal axis. The second sensor is fluidly coupled to the internal cavity of the housing at a second location with respect to the longitudinal axis. The third sensor is fluidly coupled to the internal cavity of the housing at a third location with respect to the longitudinal axis. The second location is located between the first and third locations. The first, second, and third sensors are configured to monitor one of a fluid level or a density of the sample.

In another aspect, a system for analyzing an agricultural sample has a stir chamber and a controller. The stir chamber has a housing, a first sensor, and a second sensor. The housing defines an internal cavity configured to receive an agricultural sample. The internal cavity extends along a longitudinal axis from a bottom end to a top end. The first sensor is fluidly coupled to the internal cavity of the housing at a first location with respect to the longitudinal axis. The second sensor is fluidly coupled to the internal cavity of the housing at a second location with respect to the longitudinal axis. The controller is configured to receive a plurality of signals from the first and second sensors. At least one of the plurality of signals is used to compute a density of a first region of the internal cavity located between the first and second sensors.

In yet another aspect, a method for analyzing a sample has a first step of providing a chamber having an internal cavity, the internal cavity extending along a longitudinal axis from a bottom end to a top end. Second, the first sensor is fluidly coupled to the internal cavity at a first location with respect to the longitudinal axis and a second sensor is fluidly coupled to the internal cavity at a second location with respect to the longitudinal axis. Third, a sample is added to the internal cavity. Fourth, a plurality of signals from the first and second sensors are read. Fifth, a density or a fluid level is computed using the plurality of signals from the first and second sensors.

Although the stir chamber apparatus, system, and related methods or processes for preparing an agricultural sample slurry may be described herein with reference to soil samples for convenience of description, this represents only a single category of use for the disclosed embodiments of the invention. It will therefore be understood that the same apparatus and related methods or processes may be used for processing any type of sample, not limited to agricultural samples. These samples may include any liquid, including liquid solutions and suspensions. The disclosure herein should therefore be broadly construed as an apparatus and related methods or processes for analyzing the sample regardless of the type of material or method of collection.

### BRIEF DESCRIPTION OF THE DRAWINGS

The present disclosure will become more fully understood from the detailed description and the accompanying drawings, wherein like elements are labeled similarly and in which:

FIG. 1 is a schematic of an exemplary system for analyzing an agricultural sample;

FIG. 2 is a perspective view of a stir chamber as may be used in the exemplary system for analyzing an agricultural sample as shown in FIG. 1;

FIG. 3 is a cross sectional view of the stir chamber of FIG. 2, taken along line 3-3;

FIG. 4 is a cross sectional view of the stir chamber of FIG. 3, taken along line 4-4;

FIG. 5 is a cross sectional view of the stir chamber of FIG. 2, taken along line 5-5;

FIG. 6 is a cross sectional view of the stir chamber of FIG. 2, taken along line 6-6;

FIG. 7 is a schematic view of an alternate embodiment of a stir chamber as may be used in the system of FIG. 1; and

FIG. 8 is a flow chart illustrating a method for analyzing a sample.

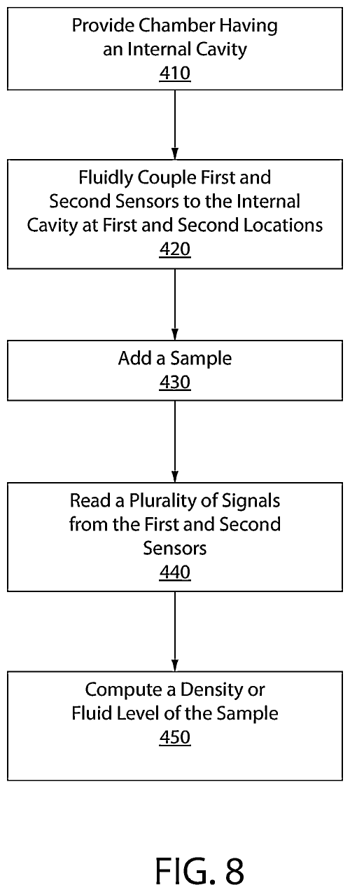

All drawings are schematic and not necessarily to scale. Components numbered and appearing in one figure but appearing un-numbered in other figures are the same components unless expressly noted otherwise. Any reference herein to a figure by a whole figure number which may appear in multiple figures bearing the same whole number prefix but with different alphabetical suffixes shall be construed as a general reference to all of those figures unless expressly noted otherwise.

### DETAILED DESCRIPTION

The features and benefits of the present disclosure are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

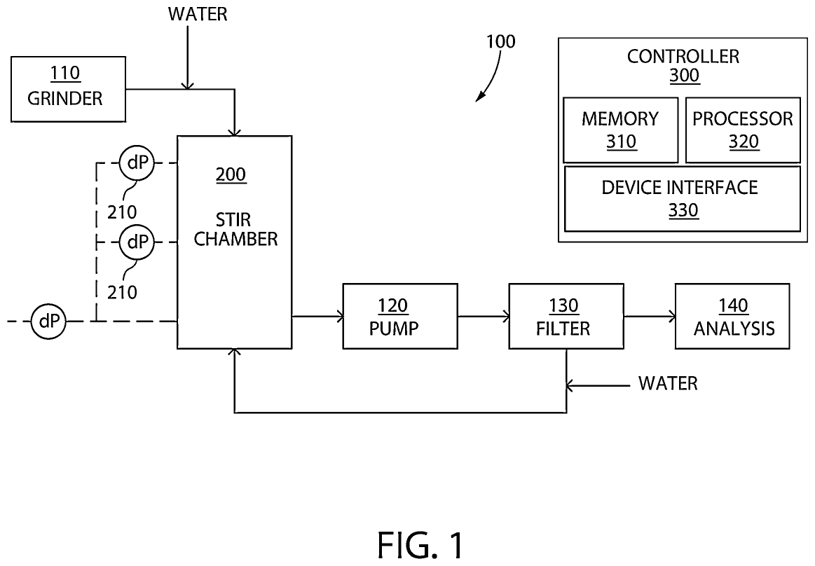

FIG. 1 illustrates a schematic view of a system for analyzing an agricultural sample 100. The system 100 comprises a grinder 110, a stir chamber 200, a pump 120, a filter 130, and an analysis unit 140. The grinder 110 receives an agricultural sample, such as soil, and grinds the sample to ensure that the particle size of the agricultural sample is below that required for later analysis. For instance, clumps of soil and plant matter may be ground to reduce them in size so that they are suitable for passing through the system. In addition, water may be added from a fluid source to facilitate effective grinding and provide a liquid slurry that eases passage of the sample through the system.

The sample then passes from the grinder 110 to the stir chamber 200. The purpose of the stir chamber 200 is to ensure that the agriculture sample is homogeneous. This may be performed by a variety of methods, including mixing, stirring, shaking, vibrating, or any other means suitable to ensure thorough mixing of the sample. In addition, measurements may be performed on the sample to verify that adequate mixing has occurred. For instance the level of the sample within the stir chamber 200, the density, or the mass may be measured in an effort to determine adequate sample size and homogeneity. Once again, water may be added from a fluid source to achieve a target density, improve homogeneity, or other purposes. The fluid source may recycle water used elsewhere in the process or may add new water. In addition, the sample may be returned to the stir chamber from downstream components to perform additional processing as will be discussed in greater detail below.

From the stir chamber 200, the sample passes to a pump 120. The pump 120 pressurizes the sample to ensure that it is effectively filtered by a filter 130. In other implementations, the pump 120 may be located downstream of the filter 130, such that the filter 130 is on the suction side of the pump 120. The pump 120 and filter 130 may be used to remove undesirably large components of the sample such as gravel that have passed through the grinder. The pump 120 and filter 130 may also be used to recirculate a portion of the sample along with additional water from a water source to enable additional treatment of the sample in the stir chamber 200. This may be done because only a portion of the sample is required for further testing. It is also possible to iteratively adjust the density and homogeneity of the sample to facilitate further analysis.

Once the sample has passed through the filter 130, the analysis unit 140 performs further analysis on some or all of the sample. This analysis may include measurement of physical properties such as density or mass. The analysis may also include a range of chemical analyses. Subsequently, the sample may be discarded. Additional water from one or more of the fluid sources may be used to flush the system and ensure accurate measurement of a future sample.

A controller 300 can control all functions of the stir chamber 300. The controller 300 can comprise a memory 310, a processor 320, and a device interface 330. The controller 300 may be a central controller which controls functions for all components of the system. In other implementations 300, the controller 300 may be integrated into a single component such as the stir chamber 200. In this implementation, additional controllers 300 may be integrated into the other components and may communicate via a bus or other communications system. Alternately, the controller 300 may be integrated into a single component and may also connect to other components in the system. As can be seen, the arrangement of the controller 300 may be distributed or may be centralized as desired.

The stir chamber 200 has a plurality of sensors 210. In the system 100, the sensors 210 are differential pressure sensors. The sensor 210 are coupled to the stir chamber 200 as illustrated, with each sensor 210 having a first side of the differential sensor coupled to the stir chamber 200. A second side of the sensor 210 may also be coupled to the stir chamber 200 or may be coupled to atmosphere as illustrated in FIG. 1. Any number of sensors 210 may be utilized as desired.

In some embodiments, all of the second sides of the sensors 210 are coupled to atmosphere and in some other embodiments, all of the second sides of the sensors 210 are coupled to the stir chamber. As can be seen, all, some, or none of the second sides of the sensors 210 may be coupled to atmosphere and all, some, or none of the second sides may be coupled to the stir chamber 200. In yet further embodiments, the sensors 210 may be absolute, atmospheric, or gauge type sensors having only a single sensing input rather than the two sides or inputs of a differential sensor. In yet other configurations, the sensors 210 may not be pressure sensors, and may instead be optical, capacitive, ultrasonic, microwave, vibrating, ultrasonic, conductivity, laser, nuclear, or other types of sensors suitable for measuring density, fluid level, pressure, or other properties of a sample. Multiple different types of sensors 210 may be utilized, and not all sensors 210 need be the same type.

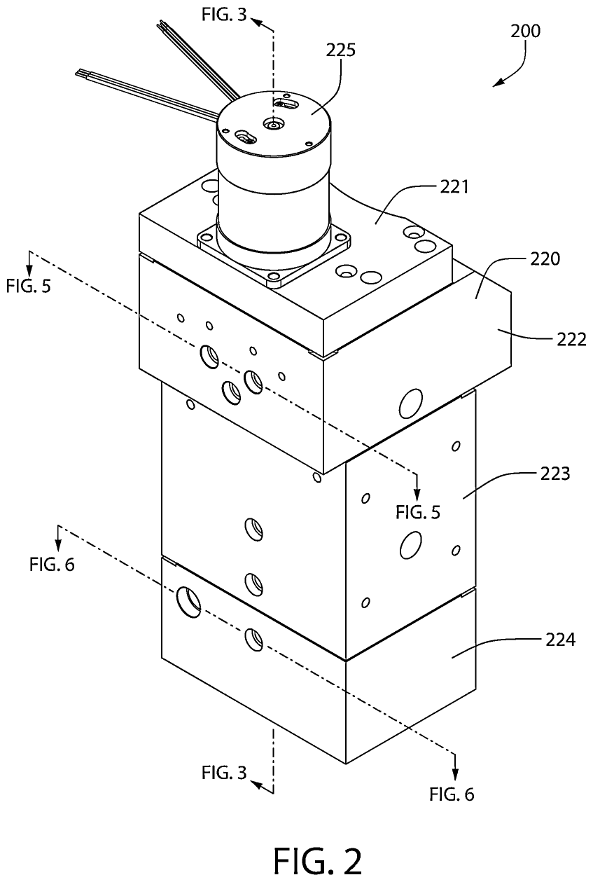

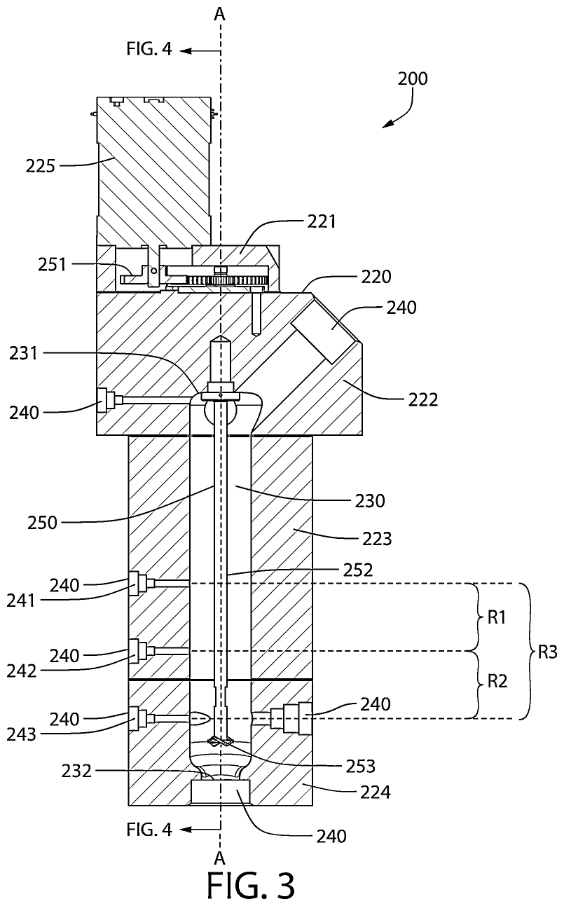

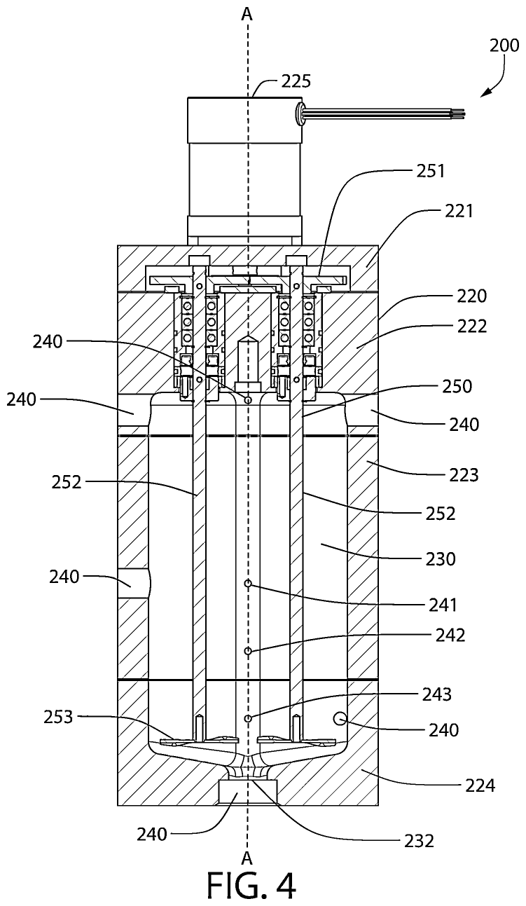

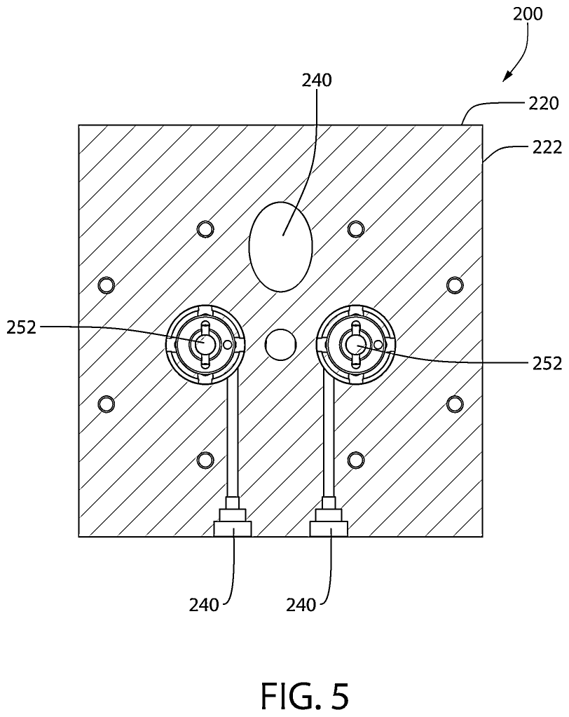

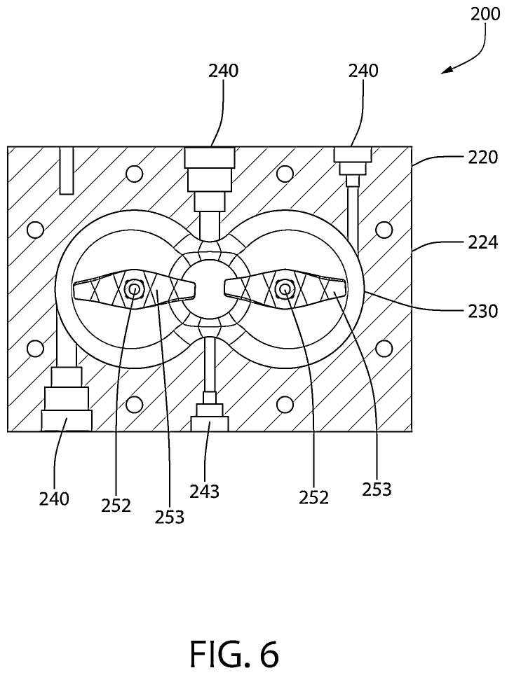

Turning to FIGS. 2-6, an exemplary embodiment of a stir chamber 200 is illustrated. The stir chamber has a housing 220 formed of a gear head 221, an upper housing 222, a middle housing 223, and a lower housing 224. The gear head 221 receives a motor 225 and couples to the upper housing 222. The upper housing 222, middle housing 223, and lower housing 224 collectively form an internal cavity 230. The internal cavity 230 extends along a longitudinal axis A-A, the internal cavity 230 being elongate along the longitudinal axis A-A. The internal cavity 230 extends along the longitudinal axis A-A from a top end 231 to a bottom end 232.

A plurality of ports 240 are formed into the housing 220 and are fluidly coupled to the internal cavity 230. The ports 240 may serve a variety of functions, including receiving a sample, outputting a sample, permitting sensors to measure the sample, allowing for injection of fluid such as water from a fluid source, or any other desired function. Optionally, some of the ports 240 may be plugged and may be utilized for optional functions which are not implemented in every system.

The plurality of ports 240 comprise a first sensing port 241, second sensing port 242, and third sensing port 243. The first, second, and third sensing ports 241, 242, 243 are arranged along the longitudinal axis A-A and fluidly coupled to the internal cavity 230. Each of the first, second, and third sensing ports 241, 242, 243 are configured to receive a sensor 210. More than three or less than three sensing ports may be utilized. One or two ports may provide adequate opportunities for sensing, while greater than three ports may provide additional granularity to the measured data.

The housing 220 is generally arranged such that the longitudinal axis A-A is vertical with respect to gravity. This ensures that the sample settles at the bottom end 232 of the internal cavity 230. Thus, a level of the sample within the internal cavity 230 can be measured using the sensing ports 241, 242, 243, with the first sensing port 241 being submerged in the sample last as the sample is delivered to the internal cavity 230.

The sensors 210 are installed into the first, second, and third sensing ports 241, 242, 243 as noted above. The sensors 210 may incorporate a fluid passage therethrough that allows clearing the first, second, and third sensing ports 241, 242, 243 in the event of clogs or to facilitate a complete rinse of the internal cavity 230. The sensors 210 are thus located at first, second, and third locations with respect to the longitudinal axis A-A. The first, second, and third locations each have a different position along the longitudinal axis A-A. A first region R1 is defined by the first and second locations of the first and second sensing ports 241, 242. A second region R2 is defined by the second and third locations of the second and third sensing ports 242, 243. A third region R3 overlaps the first and second regions R1, R2 and is defined by the first and third locations of the first and third sensing ports 241, 243.

The three different locations along the longitudinal axis allow measurements to be taken at different heights with respect to the bottom end 232 of the internal cavity 230. The controller 300 is operably coupled to the sensors 210. A plurality of signals from the sensors 210 may be received by the controller 300, allowing data collection from the sensors 210 as will be discussed in greater detail below.

The stir chamber 200 further incorporates an agitator 250. The agitator 250 collectively comprises the motor 225, a gear train 251, and two agitator shafts 252. Each agitator shaft 252 comprises a blade 253 that agitates the sample when the agitator shafts 252 are rotated. The gear train 251 connects the motor 225 to the agitator shafts 252. Optionally, more than one motor 225 may be utilized and the gear train 251 omitted. Optionally, one agitator shaft 252 or more than two agitator shafts 252 may be utilized. In yet other configurations, the gear train 251 may be formed as a belt or chain drive instead of a gear drive, but may still be referred to as a gear train 251. The gear train 251 may serve to reduce or increase the speed of the agitator shafts 252 with respect to the motor 225, or the gear train 251 may provide no reduction or multiplication of the speed of the motor 225.

In one implementation, the stir chamber 200 may utilize the sensors 210 to compute the density of the sample within the internal cavity 230. More specifically, the density of the sample may be measured in different regions within the internal cavity 230. By measuring pressure at two or more locations within the internal cavity 230, these locations being separated by a vertical distance as illustrated by the longitudinal axis A-A, it is possible to compute the density of the sample between these two locations. As long as the sample is a liquid and the locations are submerged in the sample, it is possible to measure the pressure differential at these two locations and calculate the sample's density in the region between these two locations. The fluid may be a suspension and does not need to be perfectly homogeneous.

In one method of calculating the density between two locations, the internal cavity 230 is first emptied such that it is only filled with air. The signals from the sensors 210 are then zeroed such that the readings are corrected for any deviation. Air has negligible pressure differential over the distances between the sensors 210, so it can be assumed that the pressure differential should be zero. Next, the internal cavity is filled with a reference fluid such as water, with the fluid filling the internal cavity 230 such that it covers the first, second, and third sensing ports 241, 242, 243. The reference fluid must have a known reference density. For example, the reference density of water may be arbitrarily assigned to be 1, or may be in any conventional unit system. Then, a pressure differential between any two locations is measured. For example, the pressure differential may be calculated by the controller 300 based on signals from sensors 210 in the first and second sensing ports 241, 242. Alternately, the first and third sensing ports 241, 243 or the second and third sensing ports 242, 243 may be utilized. The pressure differential between the two locations is then used as a reference differential pressure.

The signals from the sensors 210 are received by the controller 300. The signals from the sensors 210 may be in the form of an analog voltage or current, or may be a digital signal. The signals from the sensors 210 correspond to a parameter measured by the respective sensor 210. The signals may vary with respect to time, and may represent a parameter such as pressure or some other parameter which is continuously changing based on the measured condition at the respective sensing port.

Next, the internal cavity 230 is filled with a fluid of unknown density such as the agricultural sample. Once again, the two locations must be covered by the fluid of the sample. The pressure differential between the two locations is once again measured to determine a specimen differential pressure. The density may be calculated by the following formula: specimen density=reference density*specimen differential pressure/reference differential pressure. For example, if the reference density is arbitrarily assigned a value of 1, the specimen density can be determined with reference to the reference density. Specimens being twice as dense as the reference fluid would have a specimen density of 2, while specimens having half the density of the reference fluid would have a specimen density of 0.5. Alternately, the density may be defined in terms of any accepted unit system. For instance, density may be defined in terms of grams per cubic centimeter, kilograms per cubic meter, pounds per cubic foot, or any other recognized unit system.

In the event that a reference fluid of known density is not available, the internal volume and location of the sensing ports 241, 242, 243 can be utilized to calculate an expected pressure differential between two ports of a given reference fluid. This can, in turn, be used to compute a theoretical reference differential pressure that may be utilized to calculate the specimen density using the same equation as is used when an actual reference fluid is used. However, this suffers from some potential loss of accuracy due to variations in internal volume of the internal cavity 230, variations in the location of the sensors 210, and other variables.

Furthermore, a method of determining the mass of the sample can be performed. If the geometry and volume of the internal cavity 230 are known, it is possible to determine the mass of liquid within the region between the two measured points. For instance, in a cylindrical volume, the mass within the internal cavity 230 in the region between the two measured points can be determined by multiplying the specimen density by the volume within the region between the two measured points.

In yet another method, the sensors 210 can be utilized to determine a level of the sample within the internal cavity 230. By comparing the pressure measured by each sensor 210 against atmospheric pressure, the presence or absence of the sample can be determined for each location. In addition, it is possible to calculate a level between the sensors 210 by combining density measurements with pressure measurements. For instance, if the sensor 210 at the first sensing port 241 measures a pressure equal to atmospheric pressure, then the sample must have a level below the location of the first sensing port 241 with respect to the longitudinal axis A-A. If the sensor 210 at the first sensing port 241 measures a pressure greater than atmospheric pressure, then the sample must have a level above the location of the first sensing port 241. In combination with the pressure and density information, a level between ports 240 can be extrapolated. If additional sensing accuracy is desired, additional sensing ports may be added or additional sensors 210 of different types may be utilized.

In yet a further method, information regarding the density within regions of the internal cavity 230 may be used to measure the homogeneity of the sample. Where the sample is an inhomogeneous liquid (i.e. a thin suspension or other liquid of non-uniform density), measuring at three or more points will provide information on the distribution of the density of the sample in three or more regions.

For example, in the present system, the density of the sample can be measured in the first region R1 between the sensor 210 at the first sensing port 241 and the sensor 210 at the second sensing port 242. The density may also be measured in the second region R2 between the sensor 210 at the second sensing port 242 and the sensor 210 at the third sensing port 243. Finally, the density may be measured in the third region R3 between the sensor 210 at the first sensing port 241 and the sensor 210 at the third sensing port 243. Thus, the density can be measured for the first and second regions R1, R2 and the third region R3 that overlaps both the first and second regions R1, R2. Adding additional sensors 210 at additional sensing ports will allow measurements in additional regions, further increasing the information regarding the homogeneity of the sample.

As can be seen, each of the first, second, and third regions R1, R2, R3 may have different densities. The difference between the densities of the first, second, and third regions R1, R2, R3, allows a quantitative analysis of the homogeneity of the sample within the internal cavity 230. In some implementations, the agitator 250 may be activated in response to detecting a difference in density between two regions that exceeds a predetermined threshold.

In yet other implementations, where the sample has a greater density in the first region R1 than either the second or third regions R2, R3, the speed of the agitator shafts 252, or by extension, the speed of the motor 225, may be reduced to allow particles or other components of the sample to settle toward the bottom end 232 of the internal cavity 230. Where the sample has a lesser density in the first region R1 than either the second or third regions R2, R3, the speed of the agitator shafts 252, or by extension, the speed of the motor 225, may be increased to increase agitation and move particles from the second region R2 to the first region R1.

In each case, the speed of the agitator shafts 252 may be controlled using proportional control or may be activated according to a series of predetermined thresholds, with each threshold corresponding to a difference in density. In other implementations, the speed may be controlled in any known means designed to improve homogeneity of the sample. Any number of regions may be created by any number of sensors 210 as desired.

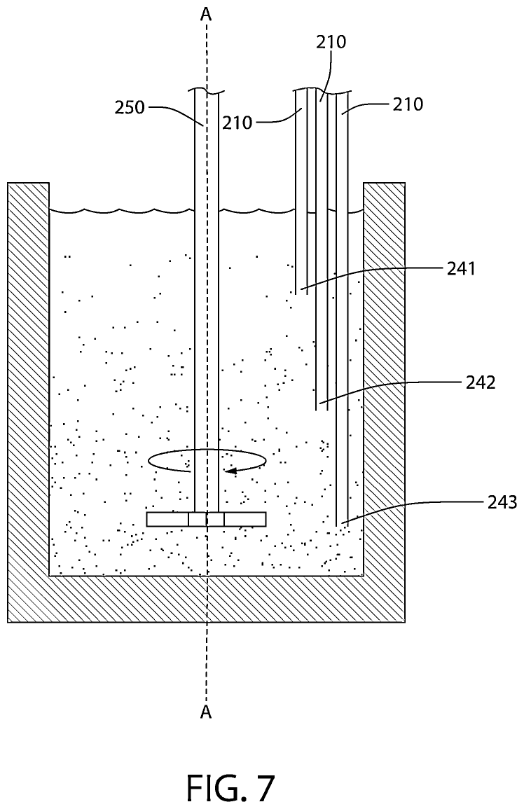

In other implementations, the sensors 210 need not be located in sensor ports as shown in the embodiment of FIGS. 2-6. In other implementations such as that shown schematically in FIG. 7, the sensors 210 may measure pressure at different locations using tubes or probes. Each tube of the sensors 210 terminates at a different location with respect to the longitudinal axis A-A to permit measurement at different heights just as with the embodiment of FIGS. 2-6. Otherwise stated, the tube of each sensor 210 terminates at a first, second, or third sensing port 241, 242, 243. A particle distribution within the sample is illustrated as having a different distribution with respect to position along the longitudinal axis A-A.

The use of an agitator 250 is optional. In some implementations, the agitator 250 may be omitted and density or fluid level measurements may be made without use of the agitator 250. In yet other implementations, the sample need not have suspended solids, but instead may be any fluid, either homogeneous or inhomogeneous.

In summary, a method for analyzing a sample 400 starts with step 410, providing a chamber 200 having an internal cavity 230. The internal cavity 230 extends along a longitudinal axis from a bottom end 232 to a top end 231. In step 420, a first sensor 210 is fluidly coupled to the internal cavity 230 at a first location with respect to the longitudinal axis A-A. A second sensor 210 is fluidly coupled to the internal cavity 230 at a second location with respect to the longitudinal axis A-A. Optionally, a third sensor 210 is fluidly coupled to the internal cavity 230 at a third location with respect to the longitudinal axis A-A. Each of the first, second, and third locations are different, and may be spaced from one another along the longitudinal axis A-A.

Subsequently, in step 430, a sample is added to the internal cavity 230. In step 440, a plurality of signals from the sensors 210 are read by the controller 300. In step 450, a density or fluid level of the sample is determined via the plurality of signals from the sensors 210. Optionally, the sensors 210 may be pressure sensors 210. Optionally, more than one density may be determined for different regions located between any two sensors as discussed above. In yet further optional configurations, the agitator 250 may be operated to increase or decrease agitation in response to the measured density in one or more different regions.

The system for analyzing an agricultural sample 100 disclosed herein is usable with and may form part of an overall agricultural sampling and analysis systems, such as but not limited to those described in U.S. Patent Application Publication No. 2018/0124992A1 and PCT Publication No. WO2020/012369, and other systems are described in U.S. Application Nos. 62/983,237, filed on 28 Feb. 2020; 63/017,789, filed on 30 Apr. 2020; 63/017,840, filed on 30 Apr. 2020; 63/018,120, filed on 30 Apr. 2020; 63/018,153, filed on 30 Apr. 2020; 63/191,147, filed on 20 May 2021; 63/191,159, filed on 20 May 2021; 63/191,166, filed on 20 May 2021; 63/191,172, filed on 20 May 2021; 17/326050, filed on 20 May 2021; 63/191,186, filed on 20 May 2021; 63/191,189, filed on 20 May 2021; 63/191,195, filed on 20 May 2021; 63/191,199, filed on 20 May 2021; 63/191,204, filed on 20 May 2021; 17/343434, filed on 9 Jun. 2021; 63/208,865, filed on 9 Jun. 2021; 17/343536, filed on 9 Jun. 2021; 63/213,319, filed on 22 Jun. 2021; 63/260,772, filed on 31 Aug. 2021; 63/260,776, filed on 31 Aug. 2021; 63/260,777, filed on 31 Aug. 2021; 63/245,278, filed on 17 Sep. 2021; 63/264,059, filed on 15 Nov. 2021; 63/264,062, filed on 15 Nov. 2021; 63/264,065, filed on 15 Nov. 2021; 63/268,418, filed on 23 Feb. 2022; 63/268,419, filed on 23 Feb. 2022; 63/268,990, filed on 8 Mar. 2022; and PCT/IB2021/051076, filed on 10 Feb. 2021; PCT Application Nos. PCT/IB2021/051077, filed on 10 Feb. 2021; PCT/IB2021/052872, filed on 7 Apr. 2021; PCT/IB2021/052874, filed on 7 Apr. 2021; PCT/IB2021/052875, filed on 7 Apr. 2021; PCT/IB2021/052876, filed on 7 Apr. 2021. Other sampling systems are described in U.S. Application Nos. 62/983,237, filed on 28 Feb. 2020; 63/017,789, filed on 30 Apr. 2020; 63/017,840, filed on 30 Apr. 2020; 63/018,120, filed on 30 Apr. 2020; 63/018,153, filed on 30 Apr. 2020; PCT/IB2021/051076, filed on 10 Feb. 2021; and PCT Application Nos. PCT/IB2021/051077, filed on 10 Feb. 2021; PCT/IB2021/052872, filed on 7 Apr. 2021; PCT/IB2021/052874, filed on 7 Apr. 2021; PCT/IB2021/052875, filed on 7 Apr. 2021; PCT/IB2021/052876, filed on 7 Apr. 2021.

All patents and patent applications referenced herein are incorporated herein by reference in their entireties.

### EXAMPLES

The following are nonlimiting examples.

Example 1—a stir chamber comprising: a housing defining an internal cavity configured to receive an agricultural sample, the internal cavity extending along a longitudinal axis from a bottom end to a top end; a first sensor fluidly coupled to the internal cavity of the housing at a first location with respect to the longitudinal axis; a second sensor fluidly coupled to the internal cavity of the housing at a second location with respect to the longitudinal axis; and a third sensor fluidly coupled to the internal cavity of the housing at a third location with respect to the longitudinal axis; wherein the second location is located between the first and third locations; and wherein the first, second, and third sensors are configured to monitor one of a fluid level or a density of the agricultural sample.

Example 2—the stir chamber according to Example 1, wherein the first sensor has a fluid passage therethrough.

Example 3—the stir chamber according to Example 2 wherein the fluid passage of the first sensor is coupled to a purge fluid source, the purge fluid source configured to supply purge fluid to the internal cavity via the fluid passage of the first sensor.

Example 4—the stir chamber according to any preceding Example further comprising an agitator configured to agitate the agricultural sample.

Example 5—the stir chamber according to Example 4 wherein the agitator comprises a blade and a motor, the motor configured to drive the blade to agitate the agricultural sample.

Example 6—the stir chamber according to any preceding Example wherein the first, second, and third sensors are pressure sensors.

Example 7—the stir chamber according to any preceding Example wherein the first, second, and third sensors are the same.

Example 8—the stir chamber according to any preceding Example wherein the stir chamber further comprises a controller operably coupled to the first, second, and third sensors.

Example 9—the stir chamber according to Example 8 wherein the controller receives a plurality of signals from the first, second, and third sensors and computes a density within the stir chamber using one or more of the plurality of signals from the first, second, and third sensors.

Example 10—the stir chamber according to Example 9 wherein the controller computes a density of the agricultural sample in a first region of the internal cavity located between the first and second sensors.

Example 11—the stir chamber according to Example 10 wherein the controller computes a density of the agricultural sample in a second region of the internal cavity located between the second and third sensors.

Example 12—the stir chamber according to Example 9 wherein the controller computes a density of the agricultural sample in a third region located between the first and third sensors.

Example 13—the stir chamber according to Example 8 wherein the controller receives signals from the first, second, and third sensors and computes a fluid level within the stir chamber.

Example 14—the stir chamber according to any preceding Example wherein the third location is adjacent the bottom end of the internal cavity.

Example 15-a system for analyzing an agricultural sample comprising: a stir chamber, the stir chamber comprising: a housing defining an internal cavity configured to receive an agricultural sample, the internal cavity extending along a longitudinal axis from a bottom end to a top end; a first sensor fluidly coupled to the internal cavity of the housing at a first location with respect to the longitudinal axis; and a second sensor fluidly coupled to the internal cavity of the housing at a second location with respect to the longitudinal axis; a controller configured to receive a plurality of signals from the first and second sensors, at least one of the plurality of signals used to compute a density of a first region of the internal cavity located between the first and second sensors.

Example 16—the system according to Example 15 wherein the first sensor has a fluid passage therethrough.

Example 17—the system according to Example 16 wherein the fluid passage of the first sensor is coupled to a purge fluid source, the purge fluid source configured to supply purge fluid to the internal cavity via the fluid passage of the first sensor.

Example 18—the system according to any of Examples 15 to 17 further comprising an agitator configured to agitate the agricultural sample.

Example 19—the system according to Example 18 wherein the agitator comprises a blade and a motor, the motor configured to drive the blade to agitate the agricultural sample.

Example 20—the system according to any of Examples 15 to 19 wherein the first and second sensors are pressure sensors.

Example 21—the system according to any of Examples 15 to 20 wherein the first and second sensors are the same.

Example 22—the system according to any of Examples 15 to 21 further comprising a third sensor fluidly coupled to the internal cavity of the housing at a third location with respect to the longitudinal axis, the second location being between the first and third locations with respect to the longitudinal axis, and the controller configured to receive a signal from the third sensor.

Example 23—the system according to Example 22 wherein the controller computes a density of the agricultural sample in a second region of the internal cavity located between the second and third sensors.

Example 24—the system according to Example 23 wherein the controller computes a density of the agricultural sample in a third region located between the first and third sensors.

Example 25—the system according to Example 23 further comprising an agitator, the controller activating the actuator in response to a difference between the density in the first region and the density in the second region.

Example 26—the system according to Example 22 wherein the controller computes a fluid level within the stir chamber.

Example 27—the system according to Example 22 wherein the third location is adjacent the bottom end of the internal cavity.

Example 28-a method for analyzing a sample, the method comprising; providing a chamber comprising an internal cavity, the internal cavity extending along a longitudinal axis from a bottom end to a top end; fluidly coupling a first sensor to the internal cavity at a first location with respect to the longitudinal axis and a second sensor to the internal cavity at a second location with respect to the longitudinal axis; adding a sample to the internal cavity; reading a plurality of signals from the first and second sensors; and computing a density or a fluid level of the sample using the plurality of signals from the first and second sensors.

Example 29—the method according to Example 28 wherein the first and second sensors are pressure sensors.

Example 30—the method according to Example 28 or 29 wherein the step of computing comprises computing a density in a first region of the internal cavity located between the first and second sensors.

Example 31—the method according to any of Examples 28 to 30 to wherein the step of fluidly coupling further comprises a third sensor fluidly coupled to the internal cavity at a third location with respect to the longitudinal axis.

Example 32—the method according to Example 31 wherein the step of reading further comprises reading at least one signal from the third sensor and the step of computing further comprises computing a density in a first region of the internal cavity between the first and second sensors and computing a density in a second region of the internal cavity located between the second and third sensors.

Example 33—the method according to Example 32 further comprising, subsequent to the computing step, a step of mixing the sample using an agitator, the step of mixing performed when the density in the first region differs from the density in the second region by a predetermined threshold.

While the foregoing description and drawings represent some example systems, it will be understood that various additions, modifications and substitutions may be made therein without departing from the spirit and scope and range of equivalents of the accompanying claims. In particular, it will be clear to those skilled in the art that embodiments of the present disclosure may be embodied in other forms, structures, arrangements, proportions, sizes, and with other elements, materials, and components, without departing from the spirit or essential characteristics thereof. In addition, numerous variations in the methods/processes described herein may be made. One skilled in the art will further appreciate that the embodiments of the present disclosure may be used with many modifications of structure, arrangement, proportions, sizes, materials, and components and otherwise, used in the practice of the embodiments of the present disclosure, which are particularly adapted to specific environments and operative requirements without departing from the principles of the present embodiments of the present disclosure. The presently disclosed embodiments are therefore to be considered in all respects as illustrative and not restrictive, the scope of the embodiments of the present disclosure being defined by the appended claims and equivalents thereof, and not limited to the foregoing description or embodiments. Rather, the appended claims should be construed broadly, to include other variants and embodiments, which may be made by those skilled in the art without departing from the scope and range of equivalents of the embodiments of the present disclosure.

1. A stir chamber comprising:
a housing defining an internal cavity configured to receive an agricultural sample, the internal cavity extending along a longitudinal axis from a bottom end to a top end;
a first sensor fluidly coupled to the internal cavity of the housing at a first location with respect to the longitudinal axis;
a second sensor fluidly coupled to the internal cavity of the housing at a second location with respect to the longitudinal axis; and
a third sensor fluidly coupled to the internal cavity of the housing at a third location with respect to the longitudinal axis;
wherein the second location is located between the first and third locations; and
wherein the first, second, and third sensors are configured to monitor one of a fluid level or a density of the agricultural sample.

2. The stir chamber according to claim 1, wherein the first sensor has a fluid passage therethrough.

3. The stir chamber according to claim 1 wherein the fluid passage of the first sensor is coupled to a purge fluid source, the purge fluid source configured to supply purge fluid to the internal cavity via the fluid passage of the first sensor.

4. The stir chamber according to claim 1 further comprising an agitator configured to agitate the agricultural sample.

5. The stir chamber according to claim 4 wherein the agitator comprises a blade and a motor, the motor configured to drive the blade to agitate the agricultural sample.

6. The stir chamber according to claim 1 wherein the first, second, and third sensors are pressure sensors.

7. The stir chamber according to claim 1 wherein the first, second, and third sensors are the same.

8. The stir chamber according to claim 1 wherein the stir chamber further comprises a controller operably coupled to the first, second, and third sensors.

9. The stir chamber according to claim 8 wherein the controller receives a plurality of signals from the first, second, and third sensors and computes a density within the stir chamber using one or more of the plurality of signals from the first, second, and third sensors.

10. The stir chamber according to claim 9 wherein the controller computes a density of the agricultural sample in a first region of the internal cavity located between the first and second sensors.

11. The stir chamber according to claim 10 wherein the controller computes a density of the agricultural sample in a second region of the internal cavity located between the second and third sensors.

12. The stir chamber according to claim 9 wherein the controller computes a density of the agricultural sample in a third region located between the first and third sensors.

13. The stir chamber according to claim 8 wherein the controller receives signals from the first, second, and third sensors and computes a fluid level within the stir chamber.

14. The stir chamber according to claim 1 wherein the third location is adjacent the bottom end of the internal cavity.

15. A system for analyzing an agricultural sample comprising:
a stir chamber, the stir chamber comprising:
a housing defining an internal cavity configured to receive an agricultural sample, the internal cavity extending along a longitudinal axis from a bottom end to a top end;
a first sensor fluidly coupled to the internal cavity of the housing at a first location with respect to the longitudinal axis; and
a second sensor fluidly coupled to the internal cavity of the housing at a second location with respect to the longitudinal axis;
a controller configured to receive a plurality of signals from the first and second sensors, at least one of the plurality of signals used to compute a density of a first region of the internal cavity located between the first and second sensors.

16. The system according to claim 15 wherein the first sensor has a fluid passage therethrough.

17. The system according to claim 16 wherein the fluid passage of the first sensor is coupled to a purge fluid source, the purge fluid source configured to supply purge fluid to the internal cavity via the fluid passage of the first sensor.

18. The system according to claim 15 further comprising an agitator configured to agitate the agricultural sample.

19. The system according to claim 18 wherein the agitator comprises a blade and a motor, the motor configured to drive the blade to agitate the agricultural sample.

20. The system according to claim 15 wherein the first and second sensors are pressure sensors.

21. The system according to claim 15 wherein the first and second sensors are the same.

22. The system according to claim 15 further comprising a third sensor fluidly coupled to the internal cavity of the housing at a third location with respect to the longitudinal axis, the second location being between the first and third locations with respect to the longitudinal axis, and the controller configured to receive a signal from the third sensor.

23. The system according to claim 22 wherein the controller computes a density of the agricultural sample in a second region of the internal cavity located between the second and third sensors.

24. The system according to claim 23 wherein the controller computes a density of the agricultural sample in a third region located between the first and third sensors.

25. The system according to claim 23 further comprising an agitator, the controller activating the actuator in response to a difference between the density in the first region and the density in the second region.

26. The system according to claim 22 wherein the controller computes a fluid level within the stir chamber.

27. The system according to claim 22 wherein the third location is adjacent the bottom end of the internal cavity.

28. A method for analyzing a sample, the method comprising;
providing a chamber comprising an internal cavity, the internal cavity extending along a longitudinal axis from a bottom end to a top end;
fluidly coupling a first sensor to the internal cavity at a first location with respect to the longitudinal axis and a second sensor to the internal cavity at a second location with respect to the longitudinal axis;
adding a sample to the internal cavity;
reading a plurality of signals from the first and second sensors; and
computing a density or a fluid level of the sample using the plurality of signals from the first and second sensors.

29. The method according to claim 28 wherein the first and second sensors are pressure sensors.

30. The method according to claim 28 wherein the step of computing comprises computing a density in a first region of the internal cavity located between the first and second sensors.

31. The method according to claim 28 wherein the step of fluidly coupling further comprises a third sensor fluidly coupled to the internal cavity at a third location with respect to the longitudinal axis.

32. The method according to claim 31 wherein the step of reading further comprises reading at least one signal from the third sensor and the step of computing further comprises computing a density in a first region of the internal cavity between the first and second sensors and computing a density in a second region of the internal cavity located between the second and third sensors.

33. The method according to claim 32 further comprising, subsequent to the computing step, a step of mixing the sample using an agitator, the step of mixing performed when the density in the first region differs from the density in the second region by a predetermined threshold.
